(19) United States
(12) Patent Application Publication
(10) Pub. No.: US 2020/0301257 A1
(43) Pub. Date: Sep. 24, 2020

(54) EXTENDABLE CAMERA ASSEMBLY FOR VEHICLE

(71) Applicant: Hercole Pietro GENOVESE, Bayswater (AU)

(72) Inventor: Hercole Pietro GENOVESE, Bayswater (AU)

(21) Appl. No.: 16/822,369

(22) Filed: Mar. 18, 2020

(30) Foreign Application Priority Data
Mar. 18, 2019 (AU) 2019900895

(51) Int. Cl. G03B 17/56; B60R 11/04

(52) U.S. Cl. CPC G03B 17/561; B60R 11/04

(57) ABSTRACT

An extendable camera assembly is for a vehicle having a number plate. The assembly includes a mount arm adapted for mounting to the vehicle via mounting bolts for the number plate. There is at least one pivot arm pivotably mounted to the mount arm and extendable therefrom between folded and extended positions. A distal end of the pivot arm is disposed away from the vehicle in the extended position, and a camera is mounted to the distal end of the at least one arm. In the extended position of the pivot arm, the camera extends outside the lateral perimeter envelope of the vehicle.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an extendable camera assembly for a vehicle. The invention is primarily intended for on road vehicles, but is not limited to this use.

### 2. Description of Related Art Including Information Disclosed Under 37 CFR 1.97 and 37 CFR 1.98

There are many instances where the view of a vehicle driver is obstructed, either by structures, trees, vehicles, or other items. These instances increase the risk of an accident.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides an extendable camera assembly for a vehicle having a number plate, the assembly comprising:
a mount arm adapted for mounting to the vehicle via mounting bolts for the number plate;
at least one pivot arm pivotably mounted to the mount arm and extendable therefrom between folded and extended positions, wherein a distal end of the pivot arm is disposed away from the vehicle in the extended position, and
a camera mounted to the distal end of the at least one arm, wherein in the extended position of the pivot arm, the camera extends outside the lateral perimeter envelope of the vehicle.

Preferably, the at least one pivot arm comprises a first arm pivotably mounted to the mount arm, and a second arm pivotably mounted to the first arm, wherein the camera is mounted to the free end of the second arm.

Preferably, the first pivot arm is pivotably connected to the mount arm at a first end thereof, with an actuatable first rotator therebetween for varying the angle between the mount arm and the first pivot arm as required.

Preferably, a second end of the first pivot arm is pivotably connected to a first end of the second arm, with an actuatable second rotator therebetween for varying the angle between the first pivot arm and the second pivot arm as required.

Preferably, a camera mount for the camera is pivotably mounted to a second end of the second pivot arm, with an actuatable third rotator therebetween for varying the orientation between the second pivot arm and the camera mount as required.

Preferably, the mount arm, the first pivot arm and the second pivot arm are adapted to be generally stacked or superimposed over each other in a folded configuration of the assembly.

Preferably, the assembly further includes control means for the driver to be able to control the distance, position and direction of the camera relative to the vehicle.

Preferably, the assembly is adapted to move back to the folded configuration thereof automatically once the vehicle starts moving.

Preferably, the maximum and preferred distance and angle settings for the camera and the pivot arms can be adjusted and set.

Preferably, the assembly further includes sensors in the camera and/or the pivot arms to avoid hitting obstacles such as structures or close vehicles.

In another embodiment, the mount arm has a first end and a second end and is adapted to extend along a bottom edge portion of the number plate, the mount arm having a flat low profile to the number plate and extends to be substantially co-extensive as the number plate between the first and second ends thereof.

In another embodiment, the at least one pivot arm comprises a first pivot arm having a first proximal end and a second distal end, wherein the first proximal end of the first pivot arm is pivotably connected to the second end of the mount arm, with an actuatable first rotator therebetween for varying the angle between the mount arm and the first pivot arm as required.

In another embodiment, a camera mount for a camera is rotatably mounted to the second distal end of the first pivot arm with an actuatable rotator therebetween for varying the rotation orientation between the first pivot arm and the camera mount as required.

In another embodiment, the camera is a 2-way camera which can view both lateral directions.

In another embodiment, a camera is fixedly mounted to the second distal end of the first pivot arm.

In another embodiment, the camera is a 360° type camera which can view in all directions.

In another embodiment, the first pivot arm is substantially of the same length as the mount arm and is parallel to the mount arm in the folded configuration, wherein in the folded configuration, the camera mount is substantially aligned with the first end of the mount arm.

In another embodiment, the mount arm is formed as a mounting plate for the number plate, being a perimeter plate with a central transparent display panel.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a perspective view of an extendable camera assembly according to a preferred embodiment of the present invention.

FIG. 2 is a top view of the assembly of FIG. 1.

FIG. 3 is a cross-section showing an example pivot point for the assembly of FIG. 1.

FIG. 4 is a perspective view of an extendable camera assembly according to another preferred embodiment of the present invention.

FIG. 5 is a front view of the assembly of FIG. 4.

FIG. 6 is a top view of the assembly of FIG. 3, with both the folded and extended position of the first pivot arm being illustrated.

### DETAILED DESCRIPTION OF THE INVENTION

It should be noted in the following description that like or the same reference numerals in different embodiments denote the same or similar features.

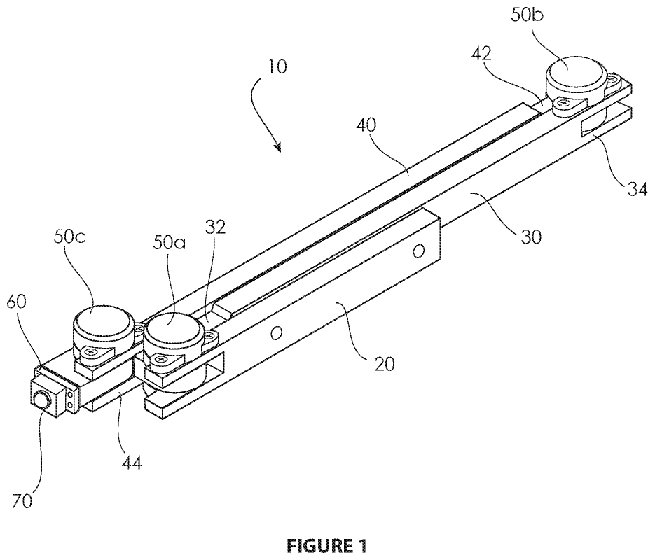

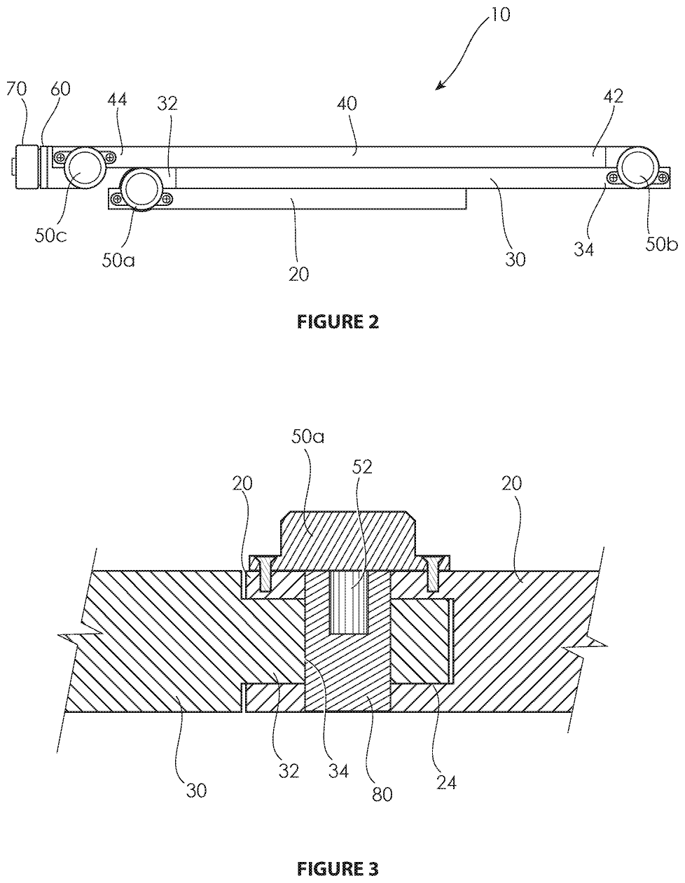

FIGS. 1 and 2 show an extendable camera assembly 10 according to a preferred embodiment of the present invention. The extendable camera assembly 10 comprises a mount arm 20, a first pivot arm 30 and a second pivot arm 40.

The mount arm 20 is adapted for mounting to the vehicle, for example to the number plate mounting points or bracket thereof. The first pivot arm 30 is pivotably connected to the mount arm 20 at a first end 32 thereof, with an actuatable first rotator 50a therebetween for varying the angle between the mount arm 20 and the first pivot arm 30 as required. A second end 34 of the first pivot arm 30 is pivotably connected to a first end 42 of the second arm 40, with an actuatable second rotator 50b therebetween for varying the angle between the first pivot arm 30 and the second pivot arm 40 as required. A camera mount 60 for a camera 70 is pivotably mounted to a second end 44 of the second pivot arm 40, with an actuatable third rotator 50c therebetween for varying the orientation between the second pivot arm 50 and the camera mount 60 as required. The mount arm 20 can alternatively be adapted for mounting directly to the vehicle, behind the number plate, to a bullbar, or other suitable bracket attached to the vehicle.

The mount arm 20, the first pivot arm 30 and the second pivot arm 40 are adapted to be generally stacked or superimposed/adjacent over each other in a folded configuration of the assembly 10 to provide a low profile when folded.

With the mount arm 20 mounted to the vehicle, actuation of the first rotator 50a pivots the first arm 30, which moves the second end 34 thereof along an arc away from or towards the vehicle. If the mount arm 20 is mounted to a front of the vehicle, the first arm 30 starts at a 0° home position thereof where the first arm 30 is adjacent and parallel, or superimposed over the mount arm 20. Pivoting the first arm 30 to a 90° angle relative to the mount arm 20 extends the second end 34 away from the vehicle in the forward direction. Pivoting the first arm 30 to a 180° angle relative to the mount arm 20 in the example extends the second end 34 towards the left side of the vehicle. The first arm can be moved to any desired angle typically between 0° and 180°, and can be returned to its home position. The first arm 30 is longer than the mount arm 20 which provides clearance for the second rotator 50b.

Similarly, actuation of the second rotator 50b pivots the second arm 30 relative to the first arm 20. The second arm 40 starts at a 0° home position thereof where the second arm 40 is adjacent and parallel, or superimposed over the first arm 30. Pivoting the second arm 40 relative to the first arm 30 moves its second end 44 away from or towards the first arm 30. The position of the second end 44 relative to the vehicle thus depends on the position of the first arm 30. The second arm 40 is longer than the first arm 30 which provides clearance for the third rotator 50c.

The third rotator 50c is actuatable for varying the orientation between the second pivot arm 50 and the camera mount 60 as required.

The rotators 50 in the embodiment are servo motors or stepper motors.

FIG. 3 is a cross-section showing an example pivot point for the assembly of FIG. 1. The example shown is the pivot point between the mount arm 20 and the first arm 30. The first rotator 50a is mounted to the mount arm 20 with a splined wheel 52 thereof extending into a cavity 24 of the mount arm 20. The first end 32 of the first arm 30 is shaped to be pivotably received in the cavity 24, with the first end 32 having an opening 34 for a pivot boss 80 to be inserted therein which locks the splined wheel 52 to the first arm 30. Rotation of the splined wheel 52 thus pivots the first pivot arm 30.

In use, the assembly 10 is fastened adjacent to the vehicle number plate and when activated can fold in and out (about 350 mm max in the example) to extend forwardly or rearwardly from the vehicle, outside the lateral perimeter envelope of the vehicle. It is activated when required by a switch or button from inside the vehicle and fully extends and retracts within about 1 second. The camera 70 at the end of the assembly 10 can rotate left to right giving a 180 degree field of view to the driver via a screen monitor located on the dashboard, which is preferably connected wirelessly.

Ideally, a respective assembly 10 is mounted to both the front and rear of the vehicle to maximize visibility. Also, the assembly 10 preferably includes control means for the driver to be able to control the distance, position and direction of the camera relative to the vehicle. The maximum and preferred distance and angle settings for the camera and the pivot arms preferably can be adjusted and set. The assembly 10 can further include sensors 75 in the camera and/or the pivot arms to avoid hitting obstacles such as structures or close vehicles. The camera when extended, extends forwardly from the vehicle and/or backwardly therefrom to extend outside the lateral perimeter envelope of the vehicle. The lateral perimeter being the perimeter of the vehicle when viewed form the top. This allows the user to see around obstructions blocking the vehicle, without exposing the vehicle to possible collision.

The invention allows the vehicle driver to “see around corners” when visibility is severely restricted to the motor vehicle driver. In one example, the assembly 10 allows the user to view around vehicles parked next to the driver when pulling away from a parking spot, where vehicles are parked side by side parallel to each other such as in a car park. This avoids the problem where the driver has no visibility at all and to exit must edge forth or backwards blindly in the hope that there is no collision with oncoming traffic which they cannot see. This scenario above applies to both ingress and egress maneuvers but especially stressful during egress.

Another example is for vehicles turning at an intersection where their view is blocked by a vehicle next to them. The assembly 10 allows the driver to see around the adjacent vehicle and execute a safe turn. The assembly 10 is adapted to move back to the folded configuration thereof automatically once the vehicle starts moving.

The assembly can thus contribute to preventing accidents, in shopping centers, car parks, and on roads, allows driver to make decisions with confidence, eliminates human error and taking chances, and potentially significantly reduce insurance premiums to vehicles fitted with the device.

Although a preferred embodiment of the present invention has been described, it will be apparent to skilled persons that modifications can be made to the embodiment shown.

The pivot points can be adapted to provide 3 degrees of freedom movement between the arms, for example by having ball and socket joints and suitable actuators therebetween.

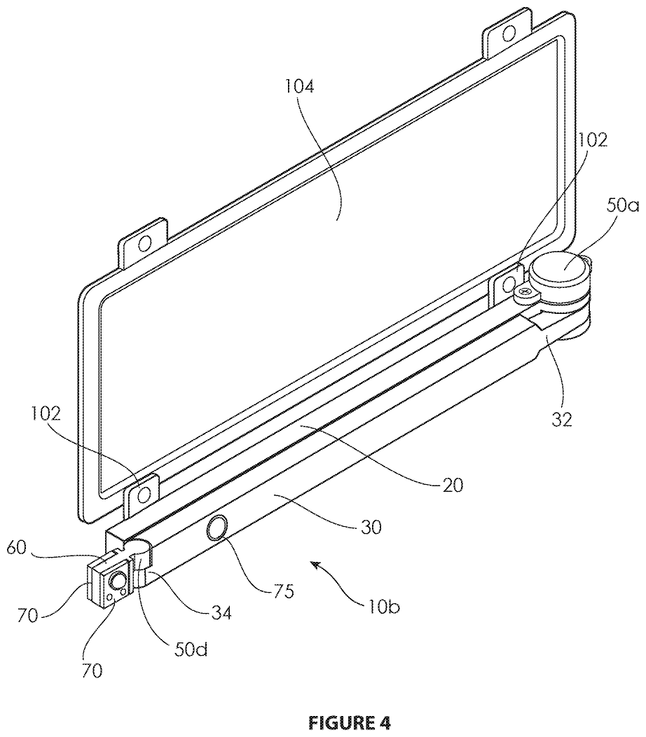

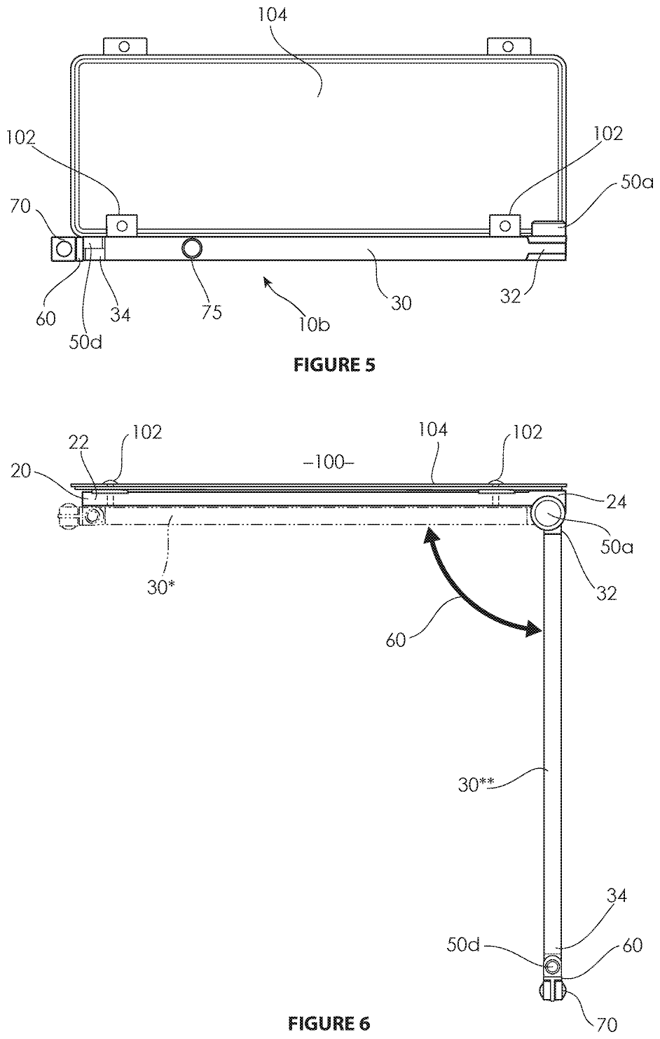

FIGS. 4 to 6 show an extendable camera assembly 10b according to another preferred embodiment of the present invention. The extendable camera assembly 10b is similar to the assembly 10 above and comprises a mount arm 20 and a first pivot arm 30. The second pivot arm 40, second rotator 50b and third rotator 50c are omitted in this embodiment.

The mount arm 20 comprises a first end 22 and a second end 24. The mount arm 20 is adapted for mounting directly to the vehicle 100, via number plate mounting bolts 102, to extend along a bottom edge portion of the number plate 104. The mount arm 20 as shown has a flat low profile to the number plate 104 and extends to be substantially co-extensive as the number plate 104.

A first proximal end 32 of the first pivot arm 30 is pivotably connected to the second end 24 of the mount arm 20, with an actuatable first rotator 50a therebetween for varying the angle between the mount arm 20 and the first pivot arm 30 as required. A camera mount 60 for a camera 70 is rotatably mounted to a second distal end 34 of the first pivot arm 30, with an actuatable rotator 50d therebetween for varying the rotation orientation between the first pivot arm 30 and the camera mount 60 as required.

Alternatively, the rotator 50d can be omitted with the camera mount 60 being fixedly attached to the distal end 34 of the first pivot arm 30. The camera 70 is preferably a 2-way camera which can view both lateral directions. Alternatively, the camera 70 can be a 360° type camera which can view in all directions.

The first pivot arm 30 is substantially of the same length as the mount arm 20 and is parallel to the mount arm 20 in the folded configuration. In the folded configuration, the camera mount 60 is substantially aligned with the first end 22 of the mount arm 20. This provides the assembly 10b with a very low profile when folded, a neat folded appearance, and will not interfere with viewing of the number plate 104.

In an alternative embodiment, the mount arm 20 can be in the form of a mounting plate for the number plate 104, such as being a perimeter plate with a central transparent display panel.

With the mount arm 20 mounted to the vehicle, actuation of the first rotator 50a pivots the first arm 30, which moves the second end 34 thereof along an arc 60 away from or towards the vehicle 100. If the mount arm 20 is mounted to a front of the vehicle, the first arm 30 starts at a 0° home position 30* thereof where the first arm 30 is adjacent and parallel, or superimposed over the mount arm 20. Pivoting the first arm 30 to a 90° angle relative to the mount arm 20 extends the second end 34 away from the vehicle in the forward direction to an extended position 30**. Pivoting the first arm 30 to a 180° angle relative to the mount arm 20 in the example extends the second end 34 towards the left side of the vehicle. The first arm can be moved to any desired angle typically between 0° and 180°, and can be returned to its home position 30*. The first arm 30 in the embodiment is typically deployed only between the 0° and 90° positions 30* and 30** as shown.

The assembly 10b when activated can fold in and out within about 1 second. The camera 70 at the end of the assembly 10 can rotate left to right giving a 180 degree field of view to the driver via a monitor located on the dashboard. The camera 70 can also be a 360° camera which will provide an all-around view.

1. An extendable camera assembly for a vehicle having a number plate, the assembly comprising:
a mount arm adapted for mounting to the vehicle via mounting bolts for the number plate;
at least one pivot arm pivotably mounted to the mount arm and extendable therefrom between a folded position and an extended positions, wherein a distal end of the pivot arm is disposed away from the vehicle in the extended position, and
a camera mounted to the distal end of the at least one arm, wherein in the extended position of the pivot arm, the camera extends outside the lateral perimeter envelope of the vehicle.

2. The assembly of claim 1 wherein the at least one pivot arm comprises a first arm pivotably mounted to the mount arm, and a second arm pivotably mounted to the first arm, wherein the camera is mounted to the free end of the second arm

3. The assembly of claim 2, wherein the first pivot arm is pivotably connected to the mount arm at a first end thereof, with an actuatable first rotator therebetween for varying the angle between the mount arm and the first pivot arm as required.

4. The assembly of claim 3, wherein a second end of the first arm is pivotably connected to a first end of the second arm, with an actuatable second rotator therebetween for varying the angle between the first arm and the second arm as required.

5. The assembly of claim 4, further comprising: a camera mount for the camera pivotably mounted to a second end of the second arm, with an actuatable third rotator therebetween for varying the orientation between the second arm and the camera mount as required.

6. The assembly of claim 2 wherein the mount arm, the first pivot arm and the second pivot arm are adapted to be generally stacked or superimposed over each other in a folded configuration of the assembly.

7. The assembly of claim 1, further comprising: control means for the driver to be able to control the distance, position and direction of the camera relative to the vehicle.

8. The assembly of claim 1 wherein the assembly is adapted to move back to the folded configuration thereof automatically once the vehicle starts moving.

9. The assembly of claim 1 wherein the maximum and preferred distance and angle settings for the camera and the pivot arms can be adjusted and set.

10. The assembly of claim 1, further comprising sensors in the camera and/or the pivot arms to avoid hitting obstacles such as structures or close vehicles.

11. The assembly of claim 1 wherein the mount arm has a first end and a second end and is adapted to extend along a bottom edge portion of the number plate, the mount arm having a flat low profile to the number plate and extends to be substantially co-extensive as the number plate between the first and second ends thereof.

12. The assembly of claim 11 wherein the at least one pivot arm comprises a first pivot arm having a first proximal end and a second distal end, wherein the first proximal end of the first pivot arm is pivotably connected to the second end of the mount arm, with an actuatable first rotator therebetween for varying the angle between the mount arm and the first pivot arm as required.

13. The assembly of claim 12, further comprising: a camera mount for a camera rotatably mounted to the second distal end of the first pivot arm with an actuatable rotator therebetween for varying the rotation orientation between the first pivot arm and the camera mount as required.

14. The assembly of claim 13 wherein the camera is a 2-way camera which can view both lateral directions.

15. The assembly of claim 12, wherein said camera is fixedly mounted to the second distal end of the first pivot arm.

16. The assembly of claim 15 wherein the camera is a 360° type camera which can view in all directions.

17. The assembly of claim 12 wherein the first pivot arm is of the same length as the mount arm and is parallel to the mount arm in the folded configuration, wherein in the folded configuration, the camera mount is aligned with the first end of the mount arm.

18. The assembly of claim 11 wherein the mount arm is formed as a mounting plate for the number plate, being a perimeter plate with a central transparent display panel.
